(19) United States
(12) Patent Application Publication
(10) Pub. No.: US 2009/0290458 A1
(43) Pub. Date: Nov. 26, 2009

(54) METHOD OF UPDATING DISC INFORMATION OF OPTICAL DISC

(76) Inventor: Tai-Liang Lin, Keelung City (TW)

Correspondence Address: NORTH AMERICA INTELLECTUAL PROPERTY CORPORATION, P.O. BOX 506, MERRIFIELD, VA, 22116, US

(21) Appl. No.: 12/125,933

(22) Filed: May 23, 2008

(51) Int. Cl. G11B 7/00

(52) U.S. Cl. 369/47.1

(57) ABSTRACT

A method of updating disc information of an optical disc includes checking whether a file system bitmap in a user data area of the optical disc had been updated, and updating disc information in a lead in area of the optical disc when the file system bitmap had been updated. By choosing an appropriate updating timing of the disc information, the present invention can reduce the risks of accidents such as power break down or abnormal host behavior occurring before the disc information is updated completely, and can prevent frequent access of locations storing the disc information.

Besides one method to choose the appropriate updating timing of disc information is introduced in this invention, one method to recover the bitmap of disc information is also introduced if the optical disc has bitmap table and bitmap table is defective.

### BACKGROUND

The present invention relates to an optical system, and more particularly, to a method of updating disc information of an optical disc.

An optical rewritable/recordable disc contains a lead-in area, followed by a user data area. Recording disc information (for example, the defect table, track information, bitmap, and etc.) is stored in the lead-in area for the disc drive to get current data layout and usage status.

Conventionally, disc information is temporarily stored and accumulated in a DRAM inside the disc drive. After a specific time period, the accumulative disc information is written into the lead-in area to update disc information in lead-in area. However, when the specific time period is too long, there is a greater risk that accidents (e.g. power break down or abnormal host behavior) will occur during the specific time period, and the disc information stored in the lead-in area may not be updated with the latest disc information, resulting in errors when the optical rewritable/recordable disc is accessed later. On the other hand, when the specific time period is too short, the region storing the disc information in the lead-in area of the rewritable/recordable disc will be updated frequently, so this region will break quickly or be exhausted due to over consumption, and the disc drive will not allow the host to record the rewritable disc again because no space to update the disc information and that can't represent the usage of user data. Therefore, selecting proper timing for updating disc information is an important issue.

### SUMMARY

One objective of the present invention is therefore to provide a method of updating disc information of an optical disc in order to solve the above problems.

Another objective of the present invention is to provide a method of updating disc information of an optical disc to reconstruct bitmap information of the optical disc if lead-in area of this disc has bitmap table and bitmap table is defective.

According to an exemplary embodiment of the present invention, a method of updating disc information of an optical disc is disclosed. The method comprises checking if a file system bitmap in a user data area of the optical disc is updated, and updating disc information in a lead-in area of the optical disc when the file system bitmap is updated.

According to another exemplary embodiment of the present invention, a method of updating disc information of an optical disc is disclosed. The method comprises checking if a write command is used to update a file system bitmap in a user data area of the optical disc, and updating disc information in a lead-in area of the optical disc when the write command is used to update the file system bitmap.

According to another exemplary embodiment of the present invention, a method of recovering the bitmap table of disc information of an optical disc is disclosed. The method comprises checking if a bitmap in a lead-in area of the optical disc is defective, and recovering and updating disc information of the bitmap in the lead-in area of the optical disc according to contents of a file system bitmap in a user data area of the optical disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a lead-in area, a user data area and a lead-out area contained in an optical rewritable/recordable disc.

FIG. 2 is a flowchart showing the process of updating disc information according to the timing when the area of a file system bitmap is updated according to one exemplary embodiment of the present invention.

FIG. 3 is a flowchart showing the process of updating disc information according to the timing when the host sends a write command that is used to update a file system bitmap area according to one exemplary embodiment of the present invention.

FIG. 4 is a diagram showing a lead-in area, a user data area and a lead-out area contained in a BD-R disc.

FIG. 5 is a flowchart showing a process of bitmap information recovery according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

In order to better update disc information stored in a non-user-data area (e.g. a lead-in area) of an optical rewritable/recordable disc, the present invention proposes a novel updating timing for the disc drive to write the accumulative disc information. The optical rewritable/recordable disc (i.e. optical rewritable disc or optical recordable disc) herein includes but is not limited to a Blu-ray recordable disc (BD-R), a Compact Disc-Rewritable (CD-RW), a Digital Versatile Disc-Rewritable (DVD-RW), a DVD+RW, a DVD-Random Access Memory (RAM), a BD-RE, and a High Definition (HD)-DVD-RW. The disc information updating therefore includes updating the recording management area (RMA) of the DVD-RW/HD-DVD-RW, the formatting disc control block (FDCB) of the DVD+RW, the defect management area (DMA) of the DVD-RAM/BD-RE and the temporary disc management area (TDMA) of the BD-R disc.

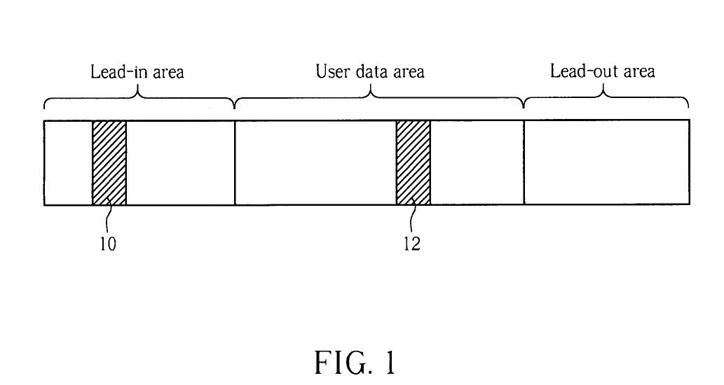

As shown in FIG. 1, a rewritable/recordable disc contains a lead-in area and a user data area, and disc information 10 recording current utilization status of the optical rewritable/recordable disc is established in the lead-in area by the disc drive. The disc drive, in one embodiment, updates the disc information 10 according to the timing when the host updates the file system bitmap 12 in the user data area. In this way, the updating of the disc information 10 and the file system bitmap 12 are synchronized, and the risks of accidents such as power break down or abnormal host behavior occurring before the disc information 10 is updated completely can be decreased, while over-consumption of the locations that store the disc information 10 resulting from frequent recording can be avoided.

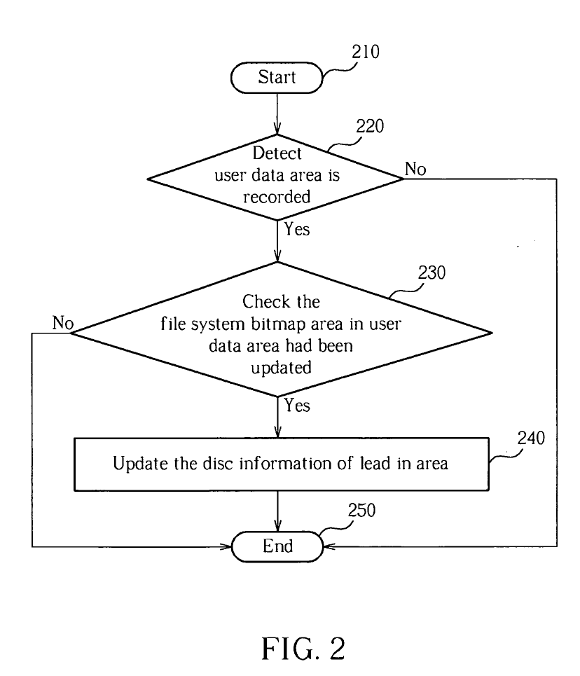

Please refer to FIG. 2, which is a flowchart showing the process of updating the disc information 10 according to the timing when the host updates the file system bitmap 12 according to an exemplary embodiment of the present invention. At first, when the disc drive has detected that the loaded disc is a rewritable/recordable disc, it detects address range of the file system bitmap 12 in the optical rewritable/recordable disc in step 210. The updating of file system bitmap 12 is essentially managed by the host, and has a fixed address after initialization. The logic address is recorded in the volume of the optical rewritable/recordable disc, and fields contained in the volume are fully specified by the file system specification of the optical rewritable/recordable disc. Step 210 can be performed during a start-up procedure of the disc drive into which the optical rewritable/recordable disc is loaded or standby time when the user data area of the rewritable disc is not accessed after the start-up procedure.

The disc drive then detects whether the user data area is recorded by the host (step 220). Since the address range of the file system bitmap 12 has been found, the disc drive can further check whether the recording is to update the file system bitmap 12 in the user data area (step 220). When the detection result is yes, i.e. the file system bitmap 12 is updated; the disc drive updates the disc information 10 in the lead-in area correspondingly (step 240). The flow chart then goes to step 250 to end this update, and may return to step 220 to detect the recording of the user data area again.

Generally speaking, updating the user data area is processing after getting a write command from the host. However, the updating of user data area will be fail sometimes even with getting the write command from the host. Thus, the previous embodiment can be taken as a situation that the disk information is updated when confirming the user data area is updated successfully.

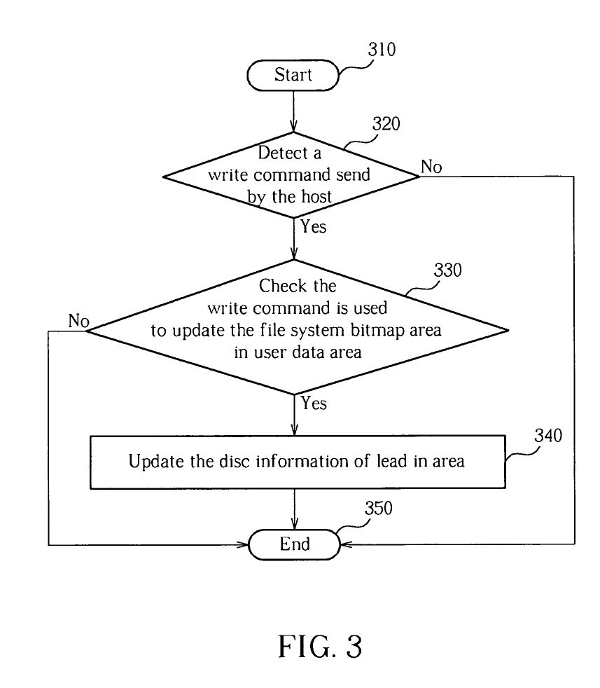

In another embodiment, as shown in the flow chart of FIG. 3, the disc drive detects a predetermined command sent by the host in order to detect the update of the file system bitmap 12 (Step 320). The disc drive determines whether a received write command is a specific write command specified for updating the file system bitmap 12 by comparing a write address associated with the received write command and the address of the file system bitmap 12 found in the start step (Step 330). After receiving the specific write command, the disc drive updates the disc information 10 by overwriting or appending the latest disc information to the disc information 10, depending on the specification of the rewritable disc (Step 340). The flow chart then goes to step 350 to end this update, and may return to step 320 to detect the receiving of the write command again.

The updating of the disc information 10 can be performed after performing the specific write command to update the file system bitmap 12 in the user data area, or after receiving the specific write command and before performing the specific write command to update the file system bitmap 12. That is, the disc information 10 can be updated before the updating of the file system bitmap 12, and vice versa.

The present invention is not limited to detect a write command relating to the file system bitmap 12. In another embodiment, the command detected in Step 320 is a control command sent by the host for controlling the disc drive to update the disc information 10. The control command may not be a standard ATA/ATAPI command, but a random command that the host negotiates with the disc drive in advance. Please note that Step 310 of reading the logic address specification can be omitted in this embodiment since the address of the file system bitmap 12 is not required in the updating process.

As well as updating the disc information of the rewritable/recordable disc, the present invention further provides a method for recovering defect bitmap of disc information of the rewritable/recordable disc. A BD-R disc with RRM is taken as an example.

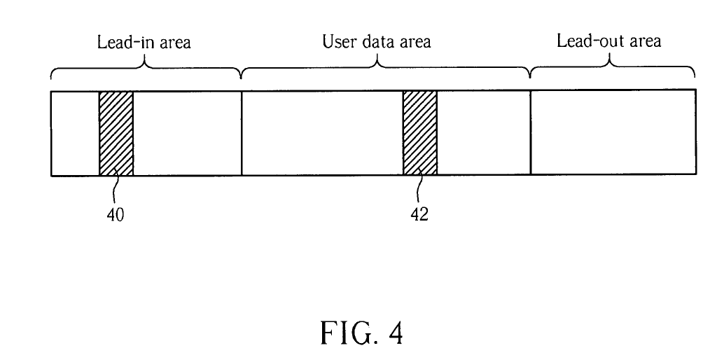

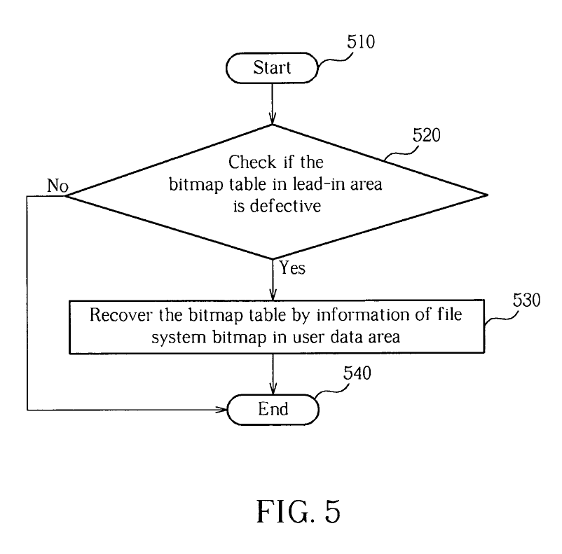

Please refer to FIG. 4. A BD-R disc comprises a lead-in area and a user data area following to the lead-in area, wherein the lead-in area records a bitmap 40 updated by the disc drive and the user data area records a bitmap 42 updated by the host respectively. When the disc drive finds that the bitmap 40 recording non-blank positions of the BD-R disc is defective, the drive repairs the bitmap 40 according to the file system bitmap 42 stored in the user data area. Please refer to FIG. 5, which is a flowchart showing a process of bitmap information recovery according to an exemplary embodiment of the present invention. In order to utilize contents of the file system bitmap 42, the drive detect an address of the file system bitmap 42 in Step 510 according the file system specification. Since detect a logic address of file system bitmap has been introduced before (in Steps 210 and 310), a detailed description is omitted here for brevity.

The disc drive then checks if the bitmap 40 in the lead-in area is defective in step 520. If the bitmap 40 is found to be defective, the disc drive reads the data of the bitmap 42 according to the address found in step 510, and recovers the bitmap 40 by referencing the file system bitmap 42 in the user data area (step 530).

One embodiment of step 530 is detailed in the following. The contents of the file system bitmap 42 are transformed to conform to a format of the bitmap 40 stored in the lead-in area because units adopted in the bitmap 40 and the file system bitmap 42 may be different. Each bit in the bitmap 40 represents the status of one ECC block of the BD-R disc, while each bit in the file system bitmap 42 represents the status of one sector of the BD-R disc. The disc drive may further decode the file system bitmap 42 in order to examine the reliability of the file system bitmap 42. When the contents of the file system bitmap are decodable (i.e. reliable), the disc drive then updates the disc information in the bitmap 40 according to the transformed contents of the file system bitmap 42. In one embodiment, the transformed contents are appended to the defect disc information in the bitmap 40 (the transformed contents are written in the next sector of the defect disc information), and a disc definition structure (DDS) changes to point to the address of the appended transformed contents rather than the address of the defect disc information. The bitmap 40 is therefore updated, and the drive can correctly analyze disc information of the BD-R disc to avoid overwriting the BD-R disc. By recovering the bitmap 40 according to the contents of the file system bitmap 42, the present invention therefore resolves the problem of the user data area not being allowed to be further written to when the bitmap 40 is found to be defective.

Those skilled in the art will readily observe that numerous modifications and alterations of the device and method may be made while retaining the teachings of the invention.

What is claimed is:

1. A method of updating disc information of an optical disc, comprising:
checking a file system bitmap in a user data area of the optical disc had been updated; and
updating disc information in a lead in area of the optical disc when the file system bitmap had been updated.

2. The method of claim 1, wherein the disc information of the optical disc comprises at least one of defect locations, non-blank locations and other information.

3. The method of claim 1, wherein the optical disc is a Blu-ray recordable disc (BD-R), a Compact Disc-Rewritable (CD-RW), a Digital Versatile Disc-Rewritable (DVD-RW), a DVD+RW, a DVD-Random Access Memory (RAM), a BD-RE, or a High Definition (HD)-DVD-RW.

4. The method of claim 1, wherein the step of checking the file system bitmap of the user data area had been updated comprises:
detecting an address of the file system bitmap according to the file system specification; and
determining whether the file system bitmap had been updated according to the address of the file system bitmap

5. The method of claim 4, wherein the step of detecting the address of the file system bitmap according to the file system specification is performed during a start-up procedure of an optical disc drive into which the optical disc is loaded or standby time when a user data area of the optical disc is not accessed after the start-up procedure of the optical disc drive.

6. A method of updating disc information of an optical disc, comprising:
checking a write command is used to update a file system bitmap in a user data area of the optical disc; and
updating disc information in a lead in area of the optical disc when the write command is used to update the file system bitmap.

7. The method of claim 6, wherein the disc information of the optical disc comprises at least one of defect locations, non-blank locations and other information.

8. The method of claim 6, wherein the optical disc is a Blu-ray recordable disc (BD-R) a Compact Disc-Rewritable (CD-RW), a Digital Versatile Disc-Rewritable (DVD-RW), a DVD+RW, a DVD-Random Access Memory (RAM), a BD-RE, or a High Definition (HD)-DVD-RW.

9. The method of claim 6, wherein the step of detecting the write command is used to update the file system bitmap comprises:
detecting an address of the file system bitmap according to file system specification; and
determining whether a received write command is the write command specified for updating the file system bitmap according to a write address associated with the received write command and the address of the file system bitmap.

10. The method of claim 9, wherein the step of reading a logic address specification of the optical disc to detect an address of the file system bitmap is performed during a start-up procedure of an optical disc drive into which the optical disc is loaded or standby time when a user data area of the optical disc is not accessed after the start-up procedure of the optical disc drive.

11. The method of claim 6, wherein the step of updating disc information in the lead in area is performed after performing the write command to update the file system bitmap in the user data area.

12. The method of claim 6, wherein the step of updating disc information in the lead in area is performed after receiving the write command and before performing the write command to update the file system bitmap in the user data area.

13. The method of claim 6, wherein the step of updating disc information in the lead in area is performed when performing the write command to update the file system bitmap in the user data area.

14. A method of updating disc information of an optical disc, comprising:
checking if a bitmap in a lead in area of the optical disc is defective and
updating disc information of the bitmap in the lead in area according to contents of a file system bitmap in a user data area of the optical disc.

15. The method of claim 14, wherein the disc information of the optical disc comprises at least one of bitmap table information and other information.

16. The method of claim 14, wherein the optical disc is a Blu-ray recordable disc (BD-R) with random recording mode (RRM), and the lead in area of the Blu-ray recordable disc comprises a Temporary Disc Management Area (TDMA) in the Blu-ray recordable disc.

17. The method of claim 14, further comprising:
detecting an address of the file system bitmap according to file system specification.

18. The method of claim 14, wherein the step of recovering bitmap of disc information in the lead in area of the optical disc comprises:
transforming the contents of the file system bitmap to form transformed contents conforming to a format of disc information stored in the lead in area; and
updating disc information in the lead in area according to the transformed contents.

19. The method of claim 18, wherein the step of updating disc information in the lead in area comprises appending the transformed contents to bitmap of the disc information of the optical disc stored in the lead in area.

20. The method of claim 14, wherein the step of updating disc information in the lead in area of the optical disc according to contents of the file system bitmap in the user data area further comprises:
decoding the contents of the file system bitmap in the user data area; and
when the contents of the file system bitmap are decodable, updating disc information in the lead in area of the optical disc according to the contents of the file system bitmap.
